(19) United States
(12) Patent Application Publication
(10) Pub. No.: US 2008/0020253 A1
(43) Pub. Date: Jan. 24, 2008

(54) Method for Producing a Membrane-Electrode Unit

(76) Inventors: Ingo Neubert, Norderstedt (DE); Sven Konig, Wedel (DE); Klaus Keite-Telgenbuscher, Hamburg (DE); Ryad Fakhri, Liezen (DE)

Correspondence Address: NORRIS, MCLAUGHLIN & MARCUS, P.A., 875 THIRD AVE, 18TH FLOOR, NEW YORK, NY, 10022, US

(21) Appl. No.: 11/570,810

(22) PCT Filed: Jun. 9, 2005
(86) PCT No.: PCT/EP05/52679

§ 371 Date: Jun. 5, 2007

(30) Foreign Application Priority Data
Jul. 9, 2004 (DE) 10 2004 083 679.2

(51) Int. Cl. H01M 4/88; H01M 4/94; H01M 8/10

(52) U.S. Cl. 429/30; 29/623.3; 429/209

(57) ABSTRACT

Process for producing a composite of catalyst material and solid electrolyte membrane for an electrochemical cell in which a catalyst material is first applied to a repellent carrier which has at least one release layer of a condensation- or radiation-crosslinked organopolysiloxane, and is then laminated at least partly onto at least one side of a membrane.

The invention relates to a process for producing an ion-conductive membrane coated with catalyst material, which can be used in electrochemical cells.

A membrane-electrode assembly (MEA) comprises a polymer electrolyte membrane (PEM) which is provided on each side with a catalyst layer. One of the catalyst layers is configured as anode, e.g. for the oxidation of hydrogen, and the second catalyst layer is configured as cathode, e.g. for the reduction of oxygen. Furthermore, gas diffusion layers can be applied to the catalyst layer. The gas diffusion layers usually comprise carbon fiber paper or woven carbon fiber fabrics and enable the reaction gases to gain ready access to the reaction layers and allow the cell current to be conducted away readily.

The performance data of a fuel cell depend critically on the quality of the catalyst layers (electrodes) applied to the PEM. The layers are usually porous and comprise a proton-conducting polymer (ionomer) and a finely divided electrocatalyst which catalyzes the respective reaction (oxidation of hydrogen or reduction of oxygen) dispersed therein. Three-phase boundaries at which the ionomer is in direct contact with the electrocatalyst and the gases brought to the catalyst particles via the porous system are formed in these layers. In the majority of cases, supported catalysts in which catalytically active platinum group metals in finely divided form have been applied to the surface of a conductive support material are used. Finely divided carbon blacks have been found to be useful as support materials.

The catalyst material can be present as a pulverulent mixture or as a liquid or paste-like preparation. The paste-like preparations for producing the catalyst layers will hereinafter be referred to as inks or catalyst inks. In addition to the supported catalyst, they generally comprise a soluble, proton-conducting material as binder, one or more solvents and, if appropriate, finely divided, hydrophobic materials and pore formers. The catalyst inks can be classified according to the type of solvent used. There are inks which contain predominantly organic solvents and ones which use predominantly water as solvent.

The binders are well known in industry. Preferred binders are perfluorinated sulfonyl fluoride polymers. Such polymers can be obtained under the trade name Nafion from I.E. du Pont. Further binders used include fluorocarbon polymers such as polytetrafluoroethylene and polyhexylfluoroethylene.

Incorporation of auxiliaries into the ink composition to form a suspension of the catalytically active particles and/or the ionomer or to aid the printing of the ink onto the surface of the membrane is also known. However, such auxiliaries interact unfavorably with many ionomers in the ink and membrane. Further auxiliaries are used as viscosity regulators.

The gas diffusion layers usually comprise coarse-pored carbon fiber paper, carbon fiber nonwoven, carbon fiber lay-ups or woven carbon fiber fabrics having porosities of up to 90%.

To utilize fuel cells as electric energy source, many membrane-electrode assemblies are arranged above one another to form a fuel cell stack. Bipolar plates are inserted between the individual membrane-electrode units to bring the reaction gases to the electrodes of the fuel cells via appropriate channels and to carry away the reaction products formed. In addition, they serve to conduct the cell current to and from the electrodes.

The use of this fuel cell stack for stationary or mobile applications, e.g. for domestic energy stations or the powering of motor vehicles by electricity, requires technical production processes for the membrane-electrode assemblies.

To apply the catalyst layer to the membrane, it is possible to make a distinction between direct coating processes and lamination processes.

In direct coating processes, the ink which is usually present in a solvent is applied directly to the membrane by printing, doctor blade coating, rolling, brushing or spraying, dried there and, if appropriate, after-treated. The direct application of catalyst inks to membranes present in protonated form proves to be difficult. Organic solvents in particular in the ink lead to swelling and distortion of the membrane (EP 0 622 861). U.S. Pat. No. 6,074,692 describes a process in which the dimensional stability of the membrane is supposed to be ensured by complicated chemical fixing. To circumvent this, nonacidic (e.g. Na⁺ or K⁺) forms on the membrane and the binder of the ink are frequently used for this process, but this requires a further process step for reprotonation, as described in EP 0 797 265.

In lamination processes, the ink is firstly applied to a carrier and laminated after drying or while still moist onto the membrane, after which the carrier is removed. As an alternative, the ink is firstly applied to the gas diffusion layer, which can also occur directly or in a further lamination process, and the coated gas diffusion layer is then laminated onto the membrane.

Known carriers having release properties are essentially antiadhesive or antiadhesively treated papers or films. Here, particularly in the case of a continuous coating or lamination process, the material thickness, the constancy of the thickness (low tolerances) and the flatness (dimensional stability) have to meet demanding requirements. Papers used are highly densified glassin papers, soft-calendered papers, machine finished papers, clay-coated papers and polymer-coated (essentially polyolefins) papers. Conceivable film materials are all known thermoplastics such as polyolefins, polyethers, polyesters, vinyl polymers and polyamides, preferably PET, PI, PP and PE.

Release systems used are silicones, paraffins, waxes, fluoropolymers (e.g. PTFE, PVDF), polyimide or polyolefins (PE, PP). The essentially known silicone-based release systems (organopolysiloxanes) are described in the company brochure by Dow Corning No. CFY01066/30-001A-01: Solutions for Release Coating Success, 2001. These are systems which are crosslinked after application to the support material. The silicone systems differ, inter alia, in terms of the type of crosslinking. Organopolysiloxanes (for the purposes of the present invention, this term also refers to oligomeric siloxanes) crosslink by addition, condensation, free-radical or cationic mechanisms, with the first two and also free-radical UV crosslinking having attained the greatest importance.

Condensation crosslinking is based, for example, on the reaction of α,ω-dihydroxypolydimethylsiloxane with silicic esters in the presence of catalysts such as dibutyltin dilaurate or tin(II) octoate. The reaction rate depends on the functionality and concentration of the crosslinker, its chemical structure and the type of catalyst. Addition crosslinking is based on the addition of SiH onto double bonds. The catalysts used are salts and complexes of noble metals such as platinum, palladium or rhodium. The reaction proceeds even at room temperature if olefin complexes of the platinum metals are used. Addition-crosslinking organopolysiloxanes for processing at elevated temperature contain nitrogen-containing platinum complexes. In the case of free-radical crosslinking, the crosslinking reaction proceeds via the formation of free radicals. As free radical formers, use is made of various peroxides which act as initiators for the free-radical reaction. Incorporation of vinyl groups into the polymer makes more targeted crosslinking possible. Another form of free-radical crosslinking is radiation crosslinking by means of ultraviolet light, electron beams or gamma rays.

As carriers for catalyst layers, use is made, according to the prior art, of PTFE films or plates (U.S. Pat. No. 5,211,984, EP 0 622 861, WO 02/061871), suitable paper (EP 0 622 861), polyimide films (EP 1 021 847) or microstructured or microrough films (EP 0 622 861). In the case of lamination of the dried catalyst layer, pressing of the composite at elevated temperature is necessary. Typical parameter ranges are 500-50 000 kPa for the pressure, from 100 to 300° C. for the temperature and from one minute to two hours for the pressing time. Good results are obtained, according to EP 0 622 861, by means of a pressure of 1380 kPa and a temperature of about 130° C., with pressure and temperature being applied for a period of two minutes.

The use of microstructured or microrough films (EP 0 622 861) enabled the temperatures necessary for transfer to be reduced to below 120° C. However, the pressure required is still from 5000 to 8000 kPa and the pressing time is 3 minutes.

DE 195 09 749 A1 describes a lamination process for the continuous production of a composite of electrode material, catalyst material and a solid electrolyte membrane, in which a catalytic layer is produced on a support from a catalytic powder comprising the electrode material, the catalyst material and the solid electrolyte material. As solid electrolyte material, use is made of Nafion, and PTFE is additionally proposed as hydrophobicizing medium and at the same time assumes a binder function. This catalytic layer is heated on a side facing away from the support in order to soften the solid electrolyte material and is rolled onto the solid electrolyte membrane under high pressure. This procedure is carried out for both sides of the solid electrolyte membrane, so that the process gives a complete membrane-electrode assembly. The support for the catalytic layer is here not a carrier but preferably serves as gas diffusion layer in the finished membrane-electrode assembly and is not removed.

Furthermore, WO 97/23919 describes a process for producing membrane-electrode assemblies in which the joining of the polymer electrolyte membrane, the electrolyte layers and the gas diffusion layers is carried out continuously in a rolling process. No carrier is used here.

U.S. Pat. No. 6,074,692 likewise describes a continuous process for coating a polymer electrolyte membrane with catalyst layers simultaneously on both sides using appropriate catalyst inks, but in this case the ink is applied directly to the membrane. Indirect transfer coating by means of a carrier is here described as expensive, slow and complicated in terms of the movement of the web.

A disadvantage of the lamination materials corresponding to the prior art and the process parameters which are therefore necessary is the rigid conditions of high temperature and high pressure which, due to the thermal and mechanical stresses, can easily lead to damage to the membrane and also have a high energy consumption. The long pressing times needed generally demand a batch process and make continuous lamination difficult.

It was an object of the invention to avoid the above-described disadvantages in the lamination of a composite material containing the catalyst layer and to provide materials and processes which provide a way of applying catalyst layers to a membrane on a large-volume scale with reduced risks of damage.

The object has surprisingly been able to be achieved in a manner which would be unforeseeable to a person skilled in the art by a process in which the catalyst material is firstly applied as a layer to a repellent carrier and is then laminated onto the membrane, with the carrier being coated on at least one side with a condensation- or radiation-crosslinked organo-polysiloxane. The subordinate claims provide advantageous embodiments of the process, embodiments of the carrier and advantageous uses.

The lamination of the layer of the catalyst material can occur directly from the carrier onto the membrane. In a further embodiment of the process of the invention, the layer of catalyst material is not laminated directly from the carrier to the membrane but onto a second support material; the resulting composite can then be laminated onto the membrane in a second step.

Since gas diffusion layers are used in addition to the catalyst layer in the fuel cell, an alternative embodiment of the process comprises, in particular, firstly laminating the catalyst layer from the carrier onto the gas diffusion layer (in the sense of the second support material) and then laminating this composite onto the membrane.

The advantage of the process of the invention is that the use of the above-described classes of organo-polysiloxanes (other release coatings such as PTFE, polyolefins or addition-crosslinked organopolysiloxanes are found to be less suitable) makes only very low forces necessary for detaching the catalyst layer from the carrier and these allow a lamination process which makes do with very short times of application of appropriate temperatures and pressures. Thus, when lamination is carried out between two opposed rollers, very short pressing times are possible and this in turn increases the possible web speeds.

Preferred organopolysiloxanes are polyalkylsiloxanes, particularly preferably polydimethylsiloxanes. Preferred functional groups are hydroxy or vinyl groups, but other groups which can bring about crosslinking via a condensation or radiation-induced free-radical reaction are also suitable. Appropriate compounds are comprehensively described in Tomanek, A.: Silicone & Technik, Hanser-Verlag, Munich 1990, in Noll, W.: Chemie und Technologie der Silicone, Verlag Chemie, Weinheim, 1975, and in the patent documents DE 43 17 909, DE 43 36 703 and are hereby incorporated by reference.

As materials for the carrier, it is possible to use papers, films, textiles or composites thereof. Owing to the high mechanical stability, the high thermal conductivity and heat resistance, metal foils are preferred. Polymer films such as those composed of polyester, polyolefins, polyamide, polycarbonate, polyacrylate and polymethacrylate have advantages in terms of the low price. As papers, preference is given to highly densified glassin papers, soft-calendered papers, machine-finished papers, clay-coated papers and polymer-coated papers.

In an advantageous embodiment, the repellent effect of the coating on the carrier is supported by a regular or irregular rough microstructure of the carrier material.

In an embodiment of the process which is particularly preferred because of the low costs, the carrier is used a number of times. This can be achieved batchwise by rolling the carrier up after lamination of the catalyst layer onto the membrane and subsequently recoating the carrier with catalyst ink or continuously by configuring the carrier as a continuous web.

The catalyst material can be present as a pulverulent mixture or as a liquid or paste-like ink. This generally comprises, in addition to the catalytically active components, a soluble, proton-conducting material as binder and, if appropriate, finely divided, hydrophobic materials, further binders and pore formers and, in the case of the ink, one or more solvents.

As catalytically active components, preference is given to using the metals of the platinum group of the Periodic Table of the Elements which can be alloyed with further metals such as cobalt, chromium, tungsten, molybdenum, iron, nickel, copper or ruthenium. Supported catalysts in which the catalytically active platinum group metals have been applied in finely divided form to the surface of a conductive support material are advantageously used. Finely divided carbon blacks have been found to be useful as support materials.

As catalyst inks, it is possible to use all the inks known from the prior art. These can be classified according to the type of solvents used. There are inks which contain predominantly organic solvents and those which use predominantly water as solvent. Thus, the documents DE 196 11 510, U.S. Pat. No. 5,871,552 and U.S. Pat. No. 5,869,416 describe catalyst inks which contain predominantly organic solvents, while EP 0 731 520 Al describes catalyst inks in which exclusively water is used as solvent. DE 100 37 074 describes inks which contain both water and organic solvents. DE 198 12 592 describes inks which contain a plurality of organic solvents which are immiscible with one another.

U.S. Pat. No. 5,871,552 proposes adding a plasticizing, high-boiling solvent to the catalyst ink. This remains in the catalyst layer even after the drying process and improves the adhesion of the ionomer particles to one another and thus contributes to an improved ion conductivity in the catalyst layer. This ink is also incorporated by reference.

Inks containing organic solvents are regarded as advantageous since these lead to a greater swelling of the membrane which in turn leads to improved bonding between membrane and catalyst layer (DE 100 50 467). Disadvantages of inks having a high content of organic solvents is, particularly in the case of mass production, the high risk of ignition which requires considerable safety precautions and also the considerable emission of organic compounds. Preference is given to inks having only a low proportion of organic solvents.

The binders used according to the invention in the catalyst material are well known in industry. Preferred binders are perfluorinated sulfonyl fluoropolymers. The sulfonyl fluoropolymers (and the corresponding perfluorinated sulfonic acid polymers) are generally fluorinated polymers having side chains which contain the group CF₂CFR_{f}SO₂X, where R_{f} is F, Cl, CF₂Cl or a C₁-C₁₀-perfluoroalkyl radical and X is F or Cl, preferably F. The side chains usually contain —OCF₂CF₂CF₂SO₂X or —OCF₂CF₂SO₂F groups, preferably the latter. Polymers which contain the side chain —OCF₂CF{CF₃}O)ₖ—(CF₂)ⱼ—SO₂F, where k is 0 or 1 and j is 2, 3, 4 or 5, and also polymers which contain the side chain —CF₂CF₂SO₂X, where X is F or Cl, are also described. Preferred polymers contain the side chain —(OCF₂CFY)ᵣ—OCF₂CFR_{f}SO₂X, where R_{f} and X are as defined above, Y is CF₃ or CCl₃ and r is 1, 2 or 3. Particular preference is given to copolymers which contain the side chain —OCF₂CF{CF₃}—OCF₂CF₂SO₂F. Such binders can be obtained under the trade name Nafion from I.E. du Pont. Further binders used include fluorocarbon polymers such as polytetrafluoroethylene and polyhexylfluoroethylene.

While the binders in the inks are generally present in solution or as a suspension in the solvent, U.S. Pat. No. 3,134,697 and DE 195 09 749 also describe thermoplastic materials or prepolymers which are used as binders in solvent-free pulverulent catalyst formulations. These materials are incorporated by reference into the present invention.

It is advantageous to incorporate auxiliaries into the ink composition in order to form a suspension of the catalytically active particles and/or the ionomer. Glycerols such as tetrabutylammonium hydroxide glycerol, various glycols such as ethylene glycol or alkoxyalcohols or aryloxyalcohols, e.g. 1-methoxy-2-propanol, are known auxiliaries which aid application of the ink to the surface of the carrier. Further auxiliaries of the cellulose type, e.g. carboxymethyl-cellulose, methylcellulose, hydroxyethylcellulose, and also cellulose, polyethylene glycol, polyvinyl alcohol, polyvinylpyrrolidine, sodium polyacrylate and polyvinyl ether are used as viscosity regulators.

The nanostructural catalyst materials mentioned in EP 1 021 847, e.g. platinum-coated hair crystals, can also be used in the process of the invention. These are advantageously deposited on the carrier in the manner described in the abovementioned document.

Solid catalyst mixtures can be applied by scattering or atomization processes, with electric charges being able to be used to aid application. The catalyst ink can be applied to the carrier by all application methods known to those skilled in the art, e.g. by doctor blade coating, brushing, roller application, printing methods such as halftone rollers, screenprinting, offset printing or flexographic printing, jet application methods, spraying or casting. This can be carried out discontinuously piece by piece but preference is given to application in a continuous process.

Since the margins of the membrane are generally fixed between bipolar plates in a stack, coating of these margins is not absolutely necessary for the function. To save costs for the catalyst material, it is advantageous to coat only discontinuous segments on the carrier corresponding to the active area of the membrane. This also makes sealing of the membrane against the plates easier. Discontinuous segments are preferably produced by printing processes, including printing processes for processing pulverulent catalyst preparations.

Since the catalyst material is generally present as a solution or dispersion in a solvent or dispersion medium, this medium has to be evaporated after coating. This is generally carried out using convection dryers, but other drying methods known to those skilled in the art, e.g. heating by means of electromagnetic waves (HF waves or microwaves), can also be used. To avoid crack formation in the catalyst layer and to minimize the risk of spontaneous ignition, it is particularly advantageous for the temperature of the heat transfer medium in the convection dryer to rise from a relatively low initial temperature to a higher intermediate or final temperature during the drying process. Initial and final temperature are preferably in the range from 20 to 200° C., particularly preferably from 40 to 120° C. This gradient can be achieved by heating of the drying medium during the drying phase or by means of a plurality of successive zones having an increasing temperature through which the material passes.

After drying, the composite can be irrigated in a water bath at elevated temperature, preferably at 80° C., to wash out any organic solvent which has not yet been completely removed from the catalyst layer. Further auxiliaries such as specific solvents (e.g. N-methyl-2-pyrrolidone) or surfactants can be added to this bath. This contributes to an increase in the functional life of the MEA.

To obtain a closer bond between the catalyst layer and the membrane, it can also be advantageous not to dry the catalyst layer on the carrier completely, but instead to leave a defined proportion of solvent or dispersion medium in the layer. This can then swell the membrane slightly during lamination and thus improve the bond between the materials.

The polymer electrolyte membrane (PEM) comprises proton-conducting polymer materials. These materials are also referred to as ionomers for short. Suitable polymers encompass copolymers of a vinyl monomer such as tetrafluoroethylene and chlorotrifluoroethylene and a perfluorovinyl monomer having an ion-exchange group, e.g. a sulfonic acid group, carboxylic acid group and phosphoric acid group, or a reactive group which can be converted into an ion-exchange group. Polymers which can be used are described, for example, in DE 42 41 150, U.S. Pat. No. 4,927,909, U.S. Pat. No. 5,264,542, EP 0 574 791, DE 42 42 692, DE 19 50 027, DE 19 50 026, and DE 19 52 7435, which are hereby explicitly incorporated by reference. Preference is given to using a tetra-fluoroethylene-fluorovinyl ether copolymer bearing sulfonic acid groups. This material is marketed, for example, under the trade name Nafion by E.I. du Pont or Flemion by Ashai Glass. However, other, in particular fluorine-free, ionomer materials such as sulfonated polyether ketones or aryl ketones or polybenzimidazoles (e.g. Celltec from Celanese/PEMEAS) can also be used. Nonionic forms of perfluorinated polymers are also possible (EP 0 622 861). Furthermore, DE 42 41 150 describes the use of many homopolymers or copolymers which are soluble in solvents and have a radical which can be dissociated into ions. For use in fuel cells or electrolysis cells, it is advantageous to use membranes having a thickness of from 5 to 200 μm.

The membrane material can be used for lamination in the acidic or nonacidic (e.g. Na⁺ or K⁺) form. The process of the invention makes it easier to use, in particular, the acidic form, so that the step of reprotonation can be omitted.

The gas diffusion layers usually comprise coarse-pored carbon fiber paper or woven carbon fiber fabrics having porosities up to 90%. To prevent flooding of the pore system by water of reaction formed at the cathode, these materials are impregnated with hydrophobic materials, for example with dispersions of polytetra-fluoroethylene (PTFE). The impregnation is followed by a calcination at from about 340 to 370° C. to melt the PTFE material.

To improve the electrical contact between the catalyst layers and the gas diffusion layers, these are frequently coated on the side facing the respective catalyst layer with a microlayer of carbon black and a fluoropolymer, which is porous and water-repellent and at the same time electrically conductive and also has a relatively smooth surface. A paste of carbon black and PTFE is generally used for this purpose and is dried and calcined at from 340 to 370° C. after application.

The lamination of the dried catalyst layer from the carrier to the membrane or gas diffusion layer is carried out under the action of pressure and heat which in each case act over a defined time. This can, according to the invention, be effected discontinuously, e.g. in a heated press, or preferably continuously in the case of mass production. Here, all continuous lamination or hot-pressing processes known to those skilled in the art, e.g. lamination in a belt press or between rollers, can be employed. Owing to the lower engineering complication and the correspondingly lower capital cost, lamination between rollers is particularly preferred. Lamination of the two sides of the membrane can be carried out successively or simultaneously. Preference is given to simultaneous lamination, since in this case the membrane is thermally stressed only once and both time and possibly the capital investment for a second lamination station are saved.

Important parameters for bonding of the catalyst layer to the membrane and strengthening of the catalyst layer within itself are pressure, temperature and time. In the case of lamination between rollers, the pressing time at a process speed of more than 0.5 m/min which is desirable for mass production is very short. At this lamination speed and an assumed line width of about 1 mm, the pressing time is only 0.1 seconds. As the lamination roller diameter increases, the line width and thus the pressing time at constant web speed increase. It is therefore advantageous to make the diameter of the lamination rollers greater than 200 mm, preferably greater than 400 mm. To increase the pressing time further and to make the pressing pressure uniform at a constant web speed, it is also advantageous to make at least one lamination roller rubbery-elastic or provide it with a rubbery-elastic coating, e.g. of silicone rubber. The elasticity broadens the contact line, so that the effective pressing time increases.

To carry out lamination either discontinuously or continuously at relatively short pressing times, it is advantageous to select a relatively high temperature of the pressing surfaces. However, at excessively high temperatures, damage to the membrane or the carrier occurs. Advantageous temperatures are therefore in the range from 80 to 250° C. Preference is given to a lamination temperature of from 140 to 200° C.

To carry out lamination either discontinuously or continuously at relatively short pressing times, it is also advantageous to select a relatively high pressure. However, at an excessively high pressure, damage to the membrane or the carrier occurs. Advantageous pressures are in the range from 500 to 10 000 kPa for a flat-bed lamination process according to the invention and from 10 to 1000 N/cm for a roller lamination process.

Particular preference is given to a roller lamination process in which the line pressure is less than 200 N/cm, the temperature is from 120 to 200° C. and the process speed is greater than 1 m/min.

To increase the process speed further, it can be advantageous to preheat at least one of the materials to be laminated. This can be effected by means of radiation (e.g. by means of IR radiators), convection (e.g. by means of a stream of hot air) or contact heating (e.g. by means of a wrap around the heated lamination roller).

It is also advantageous to carry out coating of the carrier and at least the lamination of one side of the membrane in-line.

The membranes produced by the process of the invention can advantageously be used in electrochemical cells such as electrolysis cells or fuel cells.

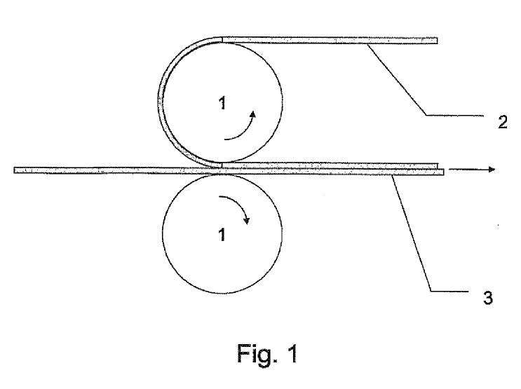

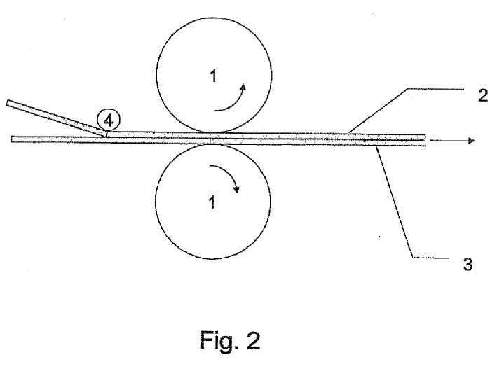

The process of the invention is illustrated with the aid of FIGS. 1 and 2, without the choice of the embodiments of the invention presented implying a restriction.

In the figures:

FIG. 1 shows roller lamination with preheating of the carrier by means of a wrap around a lamination roller
Reference numerals:
1. Lamination rollers
2. Carrier with catalyst layer
3. Membrane

FIG. 2 shows roller lamination without preheating of the carrier
Reference numerals:
1. Lamination rollers
2. Carrier with catalyst layer
3. Membrane
4. Web guide roller

Further features and advantages of the solution according to the invention are subject matter of the examples described below, without the invention being restricted further.

### EXAMPLES

Materials Used:

For the manufacture of a membrane-electrode assembly by the proposed process, a catalyst ink having the following composition was produced:

20.0 g of supported Pt catalyst (Quintech EC-20-PTC,

20% by weight of Pt on Vulcan XC-72R carbon black)

38.0 g of Nafion (1000 EW)

36.0 g of water (deionized)

10.0 g of dipropylene glycol

The Nafion solution in water/dipropylene glycol was prepared from a commercial Nafion solution (DuPont Nafion DE 1021 Dispersion: 10% by weight of tetra-fluoroethylene-fluorovinyl ether copolymer bearing sulfonic acid groups in the protonated form in water) by distilling off water and adding dipropylene glycol. The catalyst was suspended in this solution.

As polymer electrolyte membrane, use was made of a DuPont Nafion N-112 membrane (tetrafluoroethylene-fluorovinyl ether copolymer bearing sulfonic acid groups in the acidic protonated form).

As carriers, use was made of the release films and release papers shown in table 1 (support (if present) and release system of the carrier indicated in each case)

TABLE 1
Carriers used (references and according to the invention)

| Sample | | | | |
|---|---|---|---|---|
| No. | Manufacturer | Designation | Support | Release system |
| 1 | C S Hyde | Kynar 740 | — | PVDF (poly- |
| | Company | | | vinylidene |
| | | | | fluoride) |
| 2 | Platotrans | LDPE film | — | LDPE |
| 3 | Huhtamaki | OPPF 184 31020 | — | PP |
| 4 | Orbita Film | MF 93149 | — | HDPE |
| 5 | DuPont | FEP 100 | — | PTFE |
| 6 | DuPont | FEP 200 | — | PTFE |
| 7 | DuPont | FEP 300 | — | PTFE |
| 8 | Lauffenberg | KS 900 yellow | Soda | Addition- |
| | | 52B/52B12 | kraft | crosslinked |
| | | | paper | silicone |
| 9 | Lauffenberg | PETP/B50μ 53B | PETP | Addition- |
| | | | | crosslinked |
| | | | | silicone |
| 10 | Siliconature | Silphan S50 | PETP | Addition- |
| | | T74A | | crosslinked |
| | | | | silicone |
| 11 | Siliconature | Silphan S50 | PETP | Addition- |
| | | WB44A | | crosslinked |
| | | | | silicone |
| 12 | Siliconature | Silprop M 80 | BOPP | Addition- |
| | | B44A | | crosslinked |
| | | | | silicone |
| 13 | tesa | tesafix 4968 - | MOPP | Condensation- |
| | | cover (inside) | | crosslinked |
| | | | | silicone |
| 14 | tesa | tesafix 4968 - | MOPP | Condensation- |
| | | cover (outer | | crosslinked |
| | | side) | | silicone |
| 15 | Siliconature | Silphane S 23 | PETP | Condensation- |
| | | M 11 A | | crosslinked |
| | | | | silicone |
| 16 | Siliconature | Silphane S 36 | PETP | Condensation- |
| | | M 072 | | crosslinked |
| | | | | silicone |
| 17 | Siliconature | Silphane S 12 | PETP | UV-crosslinked |
| | | M2FH | | silicone |
| 18 | CP Films | UV 50 | PETP | UV-crosslinked |
| | | | | silicone |
| 19 | Siliconature | Silflu 50 B D | PETP | Fluorosilicone |
| | | 07 | | |
| 20 | Rexam | Grade 10432 | PETP | Fluorosilicone |
| | | S3Mil CL PET | | |
| | | 6J/6J | | |
| 21 | CP Films | NSR Grade | PETP | Silicone-free |
| | | | | system |
| 22 | DuPont | Kapton 100 HN | — | PI |

Test Methods:

Abrasion of the Catalyst Ink

The abrasion resistance of the ink was assessed subjectively by gently rubbing a finger on the catalyst surface. The rubbing pressure is to be kept so low that the catalyst paste is not detached from the carrier by the shear stress applied. (The latter is typically indicated by detachment of an area of the catalyst coating under the finger which corresponds approximately to the area over which the finger pressure is applied.) The evaluation was as follows:
++ no or insignificant transfer to the finger, rubbing trace in the catalyst layer not visible
+ slight transfer, rubbing trace in the catalyst layer slightly visible
− significant transfer, rubbing trace in the catalyst layer clearly visible
−− considerable transfer, catalyst layer destroyed

Release Action:

The release action of the carrier was tested by means of an adhesive tape test. For this purpose, a 15 mm wide strip of tesafilm Kristallklar (tesa AG) was applied by means of a 2 kg steel roller to the coated and dried catalyst phase (rolling back and forth 3 times). The strip of tesafilm was then pulled off by hand and the release action was evaluated as follows according to the catalyst paste residues remaining on the carrier:
++ no or insignificant residues
+ slight residues
− partially significant residues
−− residues over the entire area or virtually the entire area

Laminability Onto the Membrane:

To assess the laminability of the catalyst paste from the carrier onto the membrane, the carrier was pulled off from the catalyst layer after lamination and the laminability was evaluated as follows according to the catalyst paste residues remaining on the carrier:
++ no or insignificant residues
+ slight residues
− partially significant residues
−− residues over the entire area or virtually the entire area

### Example 1

### Drying of the Catalyst Ink

The catalyst ink was applied to the carrier No. 13 by means of a doctor blade having a 60 μm gap. Drying was carried out in a drying oven using the parameters indicated in table 2. Experiments on drying of the catalyst ink using a temperature profile were carried out by a method based on the disclosure of U.S. Pat. No. 6,074,692.

After drying, the catalyst layer was evaluated visually and the abrasion of the catalyst ink was tested subjectively. The results are summarized in table 2.

TABLE 2

| | Visual evaluation of | Abrasion of |
|---|---|---|
| Drying parameters | the catalyst layer | the catalyst ink |
| 10 min 50° C. | Uniform, crack-free | − |
| 10 min 100° C. | Spontaneous | Not able to |
| | ignition! | be evaluated |
| 30 min 50° C. | Uniform, crack-free | − |
| 10 min 50° C. + | Distinctly cracked | + |
| 10 min 100° C. | | |
| 20 min 25-110° C. | Crack-free | ++ |
| continuous profile | | |
| 20 min 60-90° C. | Crack-free | ++ |
| continuous profile | | |
| 10 min 60-90° C. | Crack-free | + |
| continuous profile | | |

These results demonstrate the advantages of drying by means of a temperature profile, in particular in respect of the crack-free formation of the catalyst layer. This is of considerable importance to the function and life of an electrochemical cell.

### Example 2

### Examination of the Release Action of Various Release Systems

The ink was applied to the various carriers by means of a doctor blade having a 60 μm gap. Drying was carried out in a drying oven, starting at a temperature of 60° C. with the temperature increasing essentially linearly to 90° C. over a period of 20 minutes. After 20 minutes, the drying procedure was stopped.

After drying, the amount of catalyst applied to the carrier was 10-15 g/m². The catalyst film was homogeneous and free of cracks.

The release action of the release systems was tested by means of the adhesive tape test. The results are summarized in table 3.

TABLE 3
Release action of the carriers

| Sample | | Release |
|---|---|---|
| No. | Release system | action |
| 1 | PVDF (polyvinylidene fluoride) | −− |
| 2 | LDPE | − |
| 3 | PP | − |
| 4 | HDPE | − |
| 5 | PTFE | − |
| 6 | PTFE | − |
| 7 | PTFE | − |
| 8 | Addition-crosslinked silicone | − |
| 9 | Addition-crosslinked silicone | − |
| 10 | Addition-crosslinked silicone | − |
| 11 | Addition-crosslinked silicone | − |
| 12 | Addition-crosslinked silicone | − |
| 13 | Condensation-crosslinked silicone | ++ |
| 14 | Condensation-crosslinked silicone | ++ |
| 15 | Condensation-crosslinked silicone | ++ |
| 16 | Condensation-crosslinked silicone | + |
| 17 | UV-crosslinked silicone | + |
| 18 | UV-crosslinked silicone | + |
| 19 | Fluorosilicone | − |
| 20 | Fluorosilicone | − |
| 21 | Silicone-free system | −− |
| 22 | PI | − |

Here, it can clearly be seen that advantageous release systems are to be found only among the condensation-crosslinked or UV-crosslinked silicone systems.

### Example 3

### Lamination of the Catalyst Layer Onto the Membrane Under a Hot Press

The catalyst ink was applied to the carrier by means of a doctor blade having a 60 μm gap. Drying was carried out in a drying oven, starting at a temperature of 60° C. with the temperature increasing essentially linearly to 90° C. over a period of 20 minutes. After 20 minutes, the drying procedure was stopped.

After drying, the amount of catalyst applied to the carrier was 10-15 g/m². The catalyst film was homogeneous and free of cracks.

Lamination was carried out between the platens of a Butrkle LAT 1.8 hot press. To indicate the pressing pressure, the punch force was divided by the area of the membrane to be laminated. This was 20 cm² throughout. To even out any tolerances in the flatness of the press platens, the composite to be pressed was firstly covered on both sides, later on one side, with a similar sized silicone rubber plate. The other side was then in contact with the steel hot press platen covered by a release paper.

Comprehensive variations of the parameters temperature, pressure and pressing time were carried out for catalyst layers applied to various carriers in order to demonstrate the possibilities of the process described.

It was necessary here to take account of, in particular, the thermal stability of the carrier which is significantly lower for MOPP materials than for PET materials.

The results of the lamination experiments are shown in table 4.

TABLE 4
Lamination of the coated catalyst paste
onto the membrane using a hot press

| | | | Temper- | Pres- | Pressing | | |
|---|---|---|---|---|---|---|---|
| | Car- | | ature | sure | time | Lamin- | |
| No. | rier | Platens | [° C.] | [kPa] | [s] | ability | Comments |
| 1 | 13 | Rubber- | 140 | 2000 | 30 | ++ | Carrier |
| | | rubber | | | | | wrinkles |
| | | | | | | | slightly |
| 2 | 13 | Rubber- | 130 | 2000 | 30 | ++ | Carrier |
| | | rubber | | | | | wrinkles |
| | | | | | | | slightly |
| 3 | 13 | Rubber- | 120 | 2000 | 135 | + | |
| | | rubber | | | | | |
| 4 | 13 | Rubber- | 120 | 3100 | 30 | −− | |
| | | rubber | | | | | |
| 5 | 13 | Rubber- | 120 | 3500 | 30 | − | |
| | | rubber | | | | | |
| 6 | 13 | Rubber- | 120 | 3800 | 30 | − | |
| | | rubber | | | | | |
| 7 | 13 | Rubber- | 120 | 4400 | 30 | + | Carrier |
| | | rubber | | | | | wrinkles |
| | | | | | | | slightly |
| 8 | 13 | Rubber- | 130 | 4700 | 30 | ++ | |
| | | steel | | | | | |
| 9 | 13 | Rubber- | 120 | 4700 | 30 | ++ | |
| | | steel | | | | | |
| 10 | 13 | Rubber- | 110 | 4700 | 30 | ++ | Also on |
| | | steel | | | | | both sides |
| 11 | 13 | Rubber- | 100 | 4700 | 30 | ++ | |
| | | steel | | | | | |
| 12 | 15 | Rubber- | 160 | 3100 | 30 | ++ | Also on |
| | | steel | | | | | both sides |
| 13 | 15 | Rubber- | 160 | 3900 | 25 | ++ | |
| | | steel | | | | | |
| 14 | 15 | Rubber- | 160 | 4700 | 20 | ++ | |
| | | steel | | | | | |
| 15 | 15 | Rubber- | 160 | 5500 | 10 | ++ | Also on |
| | | steel | | | | | both sides |
| 16 | 15 | Rubber- | 140 | 4700 | 15 | ++ | |
| | | steel | | | | | |
| 17 | 15 | Rubber- | 140 | 4400 | 5 | + | |
| | | steel | | | | | |
| 18 | 15 | Rubber- | 140 | 5500 | 5 | + | |
| | | steel | | | | | |
| 19 | 15 | Rubber- | 140 | 6300 | 5 | + | |
| | | steel | | | | | |
| 20 | 15 | Rubber- | 140 | 7100 | 5 | ++ | |
| | | steel | | | | | |
| 21 | 15 | Rubber- | 150 | 3900 | 5 | ++ | |
| | | steel | | | | | |
| 22 | 15 | Rubber- | 160 | 3100 | 5 | ++ | |
| | | steel | | | | | |
| 23 | 15 | Rubber- | 170 | 2400 | 5 | ++ | Also on |
| | | steel | | | | | both sides |

It firstly becomes clear that covering the pressing platens with rubber on one side has advantages over covering them on two sides, since wrinkling of the carrier is avoided at higher pressures in the case of covering on one side (No. 1-11).

The objective of experiments 1, 2 and 8-11 was to demonstrate the very good transferability of the catalyst layer from the carriers used according to the invention to the membrane. This can be carried out at low temperatures under very mild conditions for carrier and membrane. Thus, the temperature could be reduced to 100° C. at a pressing time of only 30 s with excellent laminability still being obtained.

The further experiments had the objective of demonstrating, with a view to the economics of the process, that very short pressing times are possible. The 5 s achieved is not the lowest possible time, but lower values could not be achieved here because of the sluggishness of the press which was available. The temperature could be kept in a moderate range for membrane and carrier (No. 16 to 20). At higher temperatures, the pressure could be reduced again (No. 20 to 23).

In the above experiments, the membrane was firstly laminated on one side. Reproductions of individual experiments using simultaneous two-sided lamination gave no differences.

### Example 4

### Lamination of the Catalyst Layer Onto the Membrane Between Two Rollers

The catalyst ink was applied by means of a doctor blade having a 60 μm gap to the carrier No. 15 in a continuous process. Drying was carried out by continuous passage through a 10 m long four-zone convection drying channel in which zone 1 was maintained at 60° C., zone 2 was maintained at 70° C., zone 3 was maintained at 80° C. and zone 4 was maintained at 100° C. The coating speed was 0.5 m/min. After passing through the drying channel, the coated web was rolled up on a six inch cardboard core.

After drying, the amount of catalyst applied to the carrier was 10-15 g/m². The catalyst film was homogeneous and free of cracks.

Lamination was carried out continuously between the rollers of various laminators. To indicate the pressing pressure, the force applied was divided by the width of the catalyst layer. This was 30 cm throughout. Lamination experiments were carried out using different material pairings (steel, rubber) of the lamination rollers.

Comprehensive variations of the parameters temperature, pressure and web speed were carried out in order to demonstrate the possibilities of the process described. In some cases, preheating of the carrier was also effected by means of a wrap around a lamination roller (see FIG. 1). If such a wrap is not indicaed, carrier and membrane contact the rollers only at the lamination line (see FIG. 2). Preheating of the membrane would also be possible but would abandon the mild conditions for this.

The results of the lamination experiments are shown in table 4.

TABLE 5
Lamination of the coated catalyst paste onto the membrane using two rollers

| | | | Temperature of | | | | |
|---|---|---|---|---|---|---|---|
| | | Wrap-around | membrane side/ | | | | Abrasion of |
| | | of carrier | carrier side | Pressure | Speed | Lamin- | the laminated |
| No. | Rollers | [° C.] | [° C.] | [N/cm] | [m/min] | ability | catalyst layer |
| 24 | Rubber- | — | 130/130 | 20 | 0.25 | + | ++ |
| | rubber | | | | | | |
| 25 | Rubber- | — | 130/130 | 20 | 0.5 | − | + |
| | rubber | | | | | | |
| 26 | Rubber- | 180 | 90/170 | 64 | 0.2 | ++ | ++ |
| | steel | | | | | | |
| 27 | Rubber- | 180 | 110/170 | 64 | 1 | ++ | ++ |
| | steel | | | | | | |
| 28 | Rubber- | 180 | 120/170 | 64 | 1.5 | ++ | ++ |
| | steel | | | | | | |
| 29 | Rubber- | 180 | 120/170 | 64 | 2 | + | ++ |
| | steel | | | | | | |
| 30 | Steel- | 90 | 120/170 | 650 | 2 | ++ | ++ |
| | steel | | | | | | |
| 31 | Steel- | 90 | 170/170 | 650 | 5 | ++ | ++ |
| | steel | | | | | | |
| 32 | Steel- | 90 | 170/170 | 650 | 10 | ++ | ++ |
| | steel | | | | | | |
| 33 | Steel- | 90 | 170/170 | 650 | 20 | ++ | ++ |
| | steel | | | | | | |
| 34 | Steel- | 90 | 170/170 | 200 | 20 | ++ | ++ |
| | steel | | | | | | |

It firstly becomes clear that higher processing speeds can be achieved with increasing temperature of the lamination rollers. Since in the case of lamination by means of a rubber roller against a steel roller the rubber roller could not be actively heated and, in addition, the lamination pressure could not be increased, the potential of this combination cannot yet be regarded as superior according to the examples. Higher processing speeds can be achieved reliably. In the case of the combination of two heated steel rollers, the limitation was in terms of the machine speed which could be set. Here too, higher plant speeds can be achieved.

1. A process for producing a composite of catalyst material and solid electrolyte membrane for an electrochemical cell, in which the catalyst material is firstly applied to a repellent carrier and consolidated there and is then laminated at least partly onto at least one side of the membrane, wherein the repellent carrier has at least one release layer comprising a condensation- or radiation-crosslinked organopolysiloxane.

2. A process for producing a composite of catalyst material and solid electrolyte membrane for an electrochemical cell, in which the catalyst material is firstly applied to a repellent carrier and consolidated there and is then laminated at least partly onto at least one side of a single-layer or multilayer second support material, with the resulting composite of the second support material and the catalyst material being applied to the membrane, wherein the repellent carrier has at least one release layer comprising a condensation- or radiation-crosslinked organopolysiloxane.

3. The process as claimed in claim 2, wherein the second support material is a gas diffusion layer.

4. The process as claimed in claim 1 or 2, wherein the organopolysiloxane is a polyalkylsiloxane.

5. The process as claimed in claim 1 or 2, wherein the carrier is a paper, a film, a textile or a composite of these materials.

6. The process as claimed in claim 5, wherein the polymer film comprises polyester, polyolefins, polyamide, polycarbonate, polyacrylate, polyimide or polymethacrylate.

7. The process as claimed in claim 5, wherein the paper is glassin paper, soft-calendered paper, machine-finished paper, clay-coated paper or polymer-coated paper.

8. The process as claimed in claim 1 or 2, wherein the carrier has a regular or irregular rough microstructure.

9. The process as claimed in claim 1 or 2, wherein the carrier is used a plurality of times.

10. The process as claimed in claim 1 or 2, wherein the catalyst material is used in the form of a paste-like preparation (“catalyst ink”).

11. The process as claimed in claim 10, wherein the catalyst ink is applied to the carrier in a continuous process by doctor blade coating, brushing, roller application, printing methods, jet application methods, spraying or casting.

12. The process as claimed in claim 1 or 2, wherein the catalyst material is applied in discontinuous segments to the carrier.

13. The process as claimed in claim 1 or 2, wherein consolidation of the catalyst material is effected by at least partial drying by a temperature profile which increases from a low initial temperature to a higher target temperature, by mechanical energy, by radiation energy and/or by heat.

14. The process of claim 1 or 2, wherein the membrane is present in the acidic form during lamination.

15. The process claim 1 or 2, wherein lamination is carried out continuously.

16. The process as claimed in claim 15, wherein the lamination is carried out between a pair of rollers, and the diameter of the rollers is greater than 200 mm

17. The process as claimed in claim 16, wherein at least one of the rollers comprises rubbery-elastic material or is provided with a rubbery-elastic coating.

18. The process as claimed in claim 1 or 2, wherein the lamination is carried out at a temperature of from 100 to 250° C.

19. The process as claimed in claim 1 or 2, wherein the lamination is carried out at a pressure of from 500 to 10 000 kPa by means of a flat-bed lamination process.

20. The process as claimed in claim 1 or 2, wherein lamination is carried out at a line pressure of from 10 to 1000 N/cm by means of a roller lamination process.

21. The process as claimed in claim 15, wherein the process speed in the lamination step is greater than 1 m/min.

22. The process as claimed in claim 15, wherein the line pressure in the lamination step is less than 700 N/cm and the temperature is from 120 to 200° C.

23. The process as claimed in claim 1 or 2, wherein at least one of the materials to be laminated is heated prior to lamination.

24. The process as claimed in claim 1 or 2, wherein lamination of both sides of the membrane is carried out simultaneously.

25. Electrolysis cells or fuel cells comprising membrane-electrode assemblies or gas diffusion layer-electrode assemblies produced by the process of claim 1 or 2.

26. The process of claim 4, wherein said polyalkylolysiloxane is a poly-dimethylsiloxane
